(19) United States
(12) Patent Application Publication
(10) Pub. No.: US 2021/0228002 A1
(43) Pub. Date: Jul. 29, 2021

(54) Furniture

(71) Applicant: Gong Ke Gouldstone, Arlington, MA (US)

(72) Inventor: Gong Ke Gouldstone, Arlington, MA (US)

(21) Appl. No.: 16/884,541

(22) Filed: May 27, 2020

Related U.S. Application Data
(60) Provisional application No. 62/965,192, filed on Jan. 24, 2020.

(51) Int. Cl. A47G 7/04; A01G 9/02

(52) U.S. Cl. CPC A47G 7/041; A01G 9/02

(57) ABSTRACT

A piece of furniture having a body with a hollow interior that includes inserts to allow the inclusion of a planting arrangement within the hollow interior is disclosed. In some embodiments, the piece of furniture includes a bottom insert within the hollow interior to protect the body from water. A template insert having openings that each accommodate a flower pot is also included within the hollow interior. The piece of furniture may be a table or a hanging shelf.

This application claims priority of U.S. Provisional patent Application 62/965,192, filed Jan. 24, 2020, the disclosure of which is incorporated herein by reference in its entirety.

### FIELD

This disclosure describes furniture that includes potted plants.

### BACKGROUND

Gardening, both indoors and outdoors, is a very popular hobby across the world. Some enjoy growing plants, also referred to as horticulture. Some enjoy environments where multiple plants form a distinct environment to be enjoyed, such as gardens and planting arrangements.

However, for many people, the space required for gardening may be problematic. For example, urban residents typically do not have outdoor space to use. Further, often apartments and condominiums have limited indoor space. Therefore, space dedicated to gardening and gardens may be limited.

However, despite the lack of space, people still desire to have plants within their living space. It is difficult for many people to place the plants to achieve a visually pleasant arrangement.

This need to incorporate plants into limited space is shared by commercial environments such as offices, cafes, restaurants, retail stores and healthcare services. In the case of commercial environments, this need is not for gardening, but rather to achieve positive wellness impact on all that occupy the space.

Therefore, it would be beneficial if there was a piece of furniture, such as a table or shelf, that could serve a functional purpose as well as supplying much needed space for a garden. Further, it would be beneficial if the piece of furniture provided a neat and convenient way to add and replace plants. Finally, it would be advantageous if the piece of furniture was accompanied by a template indicating suggested planting arrangements.

### SUMMARY

A piece of furniture having a body with a hollow interior that includes inserts to allow the inclusion of a planting arrangement within the hollow interior is disclosed. In some embodiments, the piece of furniture includes a bottom insert within the hollow interior to protect the body from water. A template insert having openings, each of which accommodates a flower pot, is also included within the hollow interior. The piece of furniture may be a table or a hanging shelf.

According to one embodiment, a piece of furniture is disclosed. The piece of furniture comprises a body having a hollow interior, a bottom surface and walls, wherein a top side of the bottom surface is an interior horizontal surface; a bottom insert disposed on the interior horizontal surface and comprising a lower surface and vertical sides extending upward from the lower surface; a template insert disposed on a top surface of the vertical sides, the template insert comprising a plurality of openings, wherein each opening is configured to accommodate a flower pot; and a top disposed above the body. In certain embodiments, the bottom insert is waterproof such that water does not contact the body. In some embodiments, the top is clear. In some embodiments, the top is constructed of a material and thickness so as to support at least 5 pounds. In certain embodiments, the top is a metal mesh. In some embodiments, a hole is disposed through one of the walls to allow water to be added onto the bottom insert. In certain embodiments, the piece of furniture comprises legs attached to the body. In some embodiments, the legs support the top. In certain embodiments, the piece of furniture comprises a support that rests on the template insert, wherein the top is disposed above the body using the support. In certain embodiments, the vertical sides extend upward from the lower surface by a length of between 4 and 12 inches. In some embodiments, a space between the template insert and the top is between 4 and 12 inches.

According to one embodiment, a piece of furniture is disclosed. The piece of furniture comprises a body having a hollow interior, a bottom surface and walls, wherein a top side of the bottom surface is an interior horizontal surface and wherein the interior horizontal surface is coated with a waterproof coating; a template insert disposed in the hollow interior above the interior horizontal surface, the template insert comprising a plurality of openings, wherein each opening is configured to accommodate a flower pot; and a top disposed above the body. In certain embodiments, the piece of furniture comprises supports to hold the template insert above the interior horizontal surface. In some embodiments, the piece of furniture comprises a ledge disposed along an interior surface of the walls, wherein the ledge is configured to hold the template insert above the interior horizontal surface. In certain embodiments, the piece of furniture comprises legs attached to the body. In some embodiments, the legs support the top. In certain embodiments, the piece of furniture comprises a support that rests on the template insert, wherein the top is disposed above the body using the support.

According to another embodiment, a hanging piece of furniture is disclosed the hanging piece of furniture comprises a template insert, the template insert comprising a plurality of openings, wherein each opening is configured to accommodate a flower pot; a waterproof container suspended from each opening; and rods disposed proximate the ends of the template insert, to allow the template insert to be suspended from above. In certain embodiments, the rods pass through an entirety of a width of the template insert. In certain embodiments, each opening comprises a notch to allow water to be added directly into the waterproof container.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a piece of furniture according to one embodiment;

FIG. 2 is an expanded view of the interior of the piece of furniture of FIG. 1;

FIG. 3 is a top view of the piece of furniture of FIG. 1;

FIG. 4 is another embodiment of a piece of furniture having a body and a template insert;

FIG. 5 shows a hanging piece of furniture, or shelf, that utilizes a template insert;

FIG. 6 shows a side view of the hanging piece of furniture shown in FIG. 5;

FIG. 7 shows a perspective view of the hanging piece of furniture; and

FIG. 8 shows a top view of the openings in the template insert of FIG. 5.

### DETAILED DESCRIPTION

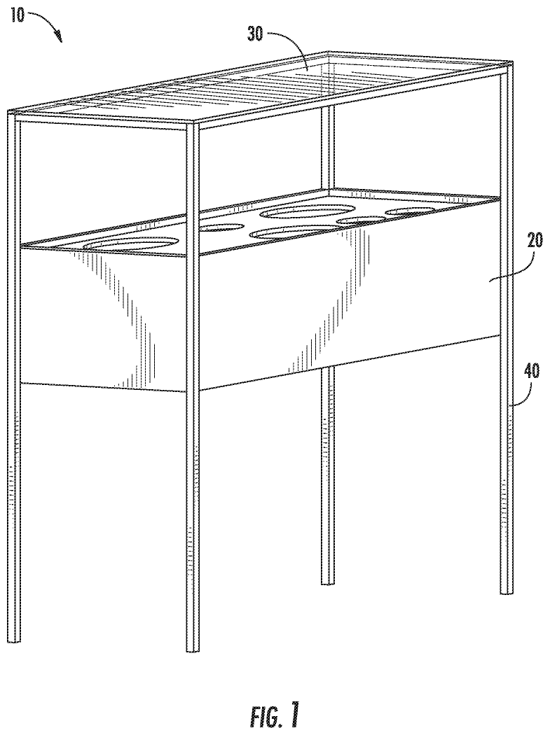

FIG. 1 shows a piece of furniture that may serve both a functional purpose as well as provide space for one or more plants, without sacrificing any horizontal surface area. This piece of furniture may be a dresser, chest of drawers, end table, or another piece that has a flat upper surface.

FIG. 1 shows a table 10, which includes a body 20, a top 30 and a plurality of legs 40. While FIG. 1 shows a table 10 with four legs 40, it is noted that the application is not limited to this number.

The legs 40 may be any suitable material, such as wood, metal or plastic. The legs may be straight, such as is shown in FIG. 1, or may be more ornate. The shape and length of the legs 40 is not limited by this disclosure. For example, the legs may be of a length so that the top of the piece of furniture is within 2 and 4 feet from the floor.

The body 20 may have a hollow interior, as described in more detail below. The body 20 includes a bottom surface with walls extending upward from the bottom surface. The bottom surface may be about 12 inches above the level of the ground in one embodiment. The top side of the bottom surface, which defines one side of the hollow interior, is referred to as the interior horizontal surface.

The top 30 rests on top of the legs 40, so as to provide an outer horizontal surface. The top 30 may be a clear material, such as glass or plastic. This serves two purposes. First, the clear material allows light to reach the plants that are disposed in the hollow interior beneath the top 30. Second, the clear material allows the owner or resident to view the plants.

The top 30 may be of a material and thickness so as to support items that are traditionally placed upon a table, such as lamps, books, drinking glasses and the like. Thus, in certain embodiments, the top 30 may be capable of supporting at least 5 pounds.

The top 30 may be disposed above the top of the body 20. In certain embodiments, there may be at least 6 inches between the top of the body 20 and the top 30. This allows space for the plants to grow without contacting the underside of the top 30. This may also allow space for the gardener to easily reach in and perform basic plant care tasks, such as trimming and watering.

As an illustrative example, the body 20 may have a width of 10 inches, a length of 18 inches and a height of 6 inches. Of course, other dimensions may also be used. It is noted that the width and length of the body 20 may be the same as the dimensions of the top 30. Further, the bottom of the body 30 may be located about 12 inches above the floor.

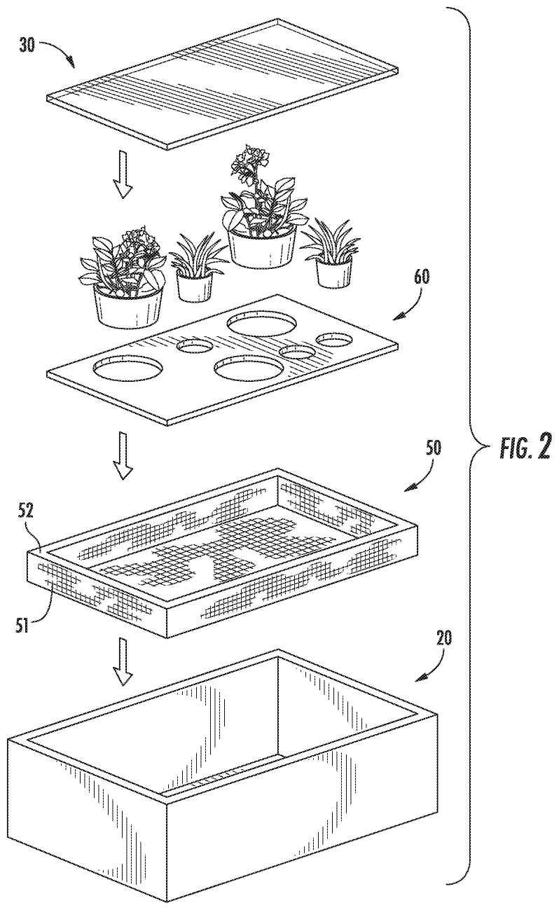

FIG. 2 shows an expanded view of the body 20 and the top 30. Within the body 20 is a bottom insert 50. The bottom insert 50 is preferably made of a waterproof material, such as plastic. Further, the bottom insert 50 may serve as a liner for the interior of the body 20. The bottom insert 50 has a lower surface 51 that is intended to rest on the interior horizontal surface of the body 20. The shape and size of the lower surface 51 may be the same or smaller than the interior dimension of the interior horizontal surface of the body 20.

In certain embodiments, the bottom insert 50 may include vertical walls 52 which extend upward from the bottom surface 51. In some embodiments, the vertical walls 52 may be sufficiently strong so as to support the template insert 60. The vertical walls 52 may be sufficiently tall so as to accommodate a 6″ flower pot. In certain embodiments, the vertical walls 52 may be between 4 and 12 inches, such as about 6 inches.

In certain embodiments, the vertical walls 52 are integral with the lower surface 51, such that the bottom insert 50 is a single waterproof component.

A template insert 60 rests on the vertical walls 52. The template insert 60 may be constructed of a water resistant material, such as plastic, wood or another suitable material. The template insert 60 may include a plurality of openings, each sized to accommodate one flower pot.

The vertical walls 52 may extend to any height than is less than the height of the body 20. In certain embodiments, the vertical walls 52 extend to a height that is at least 4 inches less than the height of the body 20 to allow space for the plants to grow. In other embodiments, the vertical walls 52 may extend to a lesser extent.

Further, the vertical walls 52 may extend to a height that is sufficiently small so that the flower pots either touch the bottom insert 50 or have a capillary wick that reaches the bottom insert 50. Watering is done by pouring water into the bottom insert 50 and absorbed into the flower pot via capillary reaction. This method of watering from the bottom is the preferred method by commercial growers and makes for healthier root systems. In addition, it minimizes splashing on top that can discolor the template insert 60 or the top 30.

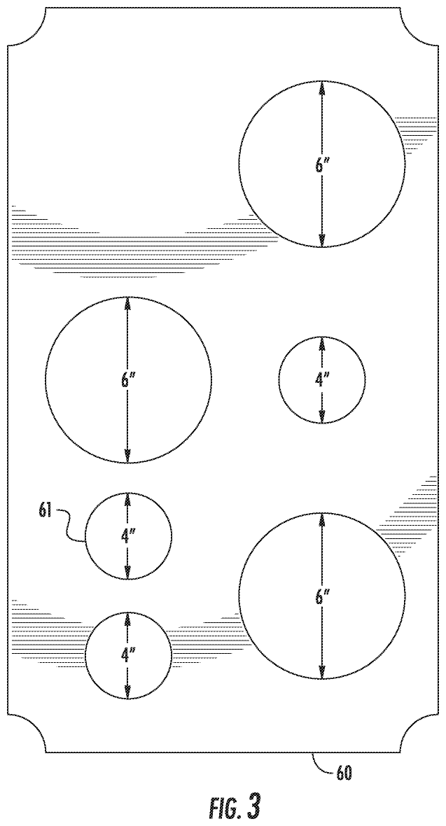

FIG. 3 shows a top view of the template insert 60. The template insert 60 may include one or more openings 61. The pattern of openings 61 may be referred to as a template. The openings 61 may be different sizes, such as those shown in FIG. 3. In the example shown in FIG. 3, openings are created to accommodate 2″, 4″ and 6″ diameter round flower pots. Of course, other sizes may also be used. The holes may be sized such that the collar of a typical flower pot remains above the template insert 60, while the rest of the flower pot is suspended below the template insert 60.

Further, the openings 61 may be arranged in any pattern. For example, the openings 61 may be arranged as a regular array having rows and columns, where the number of openings in each row is the same. Other patterns may also be created.

In certain embodiments, the template insert 60 simply rests on the vertical walls 52. In this way, a different template insert 60, having a different template, may replace the currently installed template insert 60 if desired.

Thus, in practice, the bottom insert 50 is placed in the hollow interior of the body 20. The bottom insert 50 is intended to rest on the interior horizontal surface of the body 20. The template insert 60 is then placed on top of the bottom insert 50. As described above, the template insert 60 may rest on the vertical walls 52 of the bottom insert 50. The plants, each growing in their respective flower pot, are then inserted into a corresponding opening 61 in the template insert 60. The top 30 is then placed on the top of the body 20. The top 30 may then also be used to support other objects, such as books, lamps, drinking glasses, and the like.

Furthermore, in certain embodiments, a hole may be disposed on the side of the body 20. This hole is disposed between the template insert 60 and the bottom insert 50. This hole allows the user to add water onto the bottom insert 50, as described above.

While the above description discloses a bottom insert 50 having vertical walls 52 to support the template insert 60, other embodiments are also possible.

For example, in certain embodiments, the bottom insert 50 may be eliminated and replaced with a waterproof material that is sprayed on the interior surfaces of the body 20. In this embodiment, a ledge may be provided along the interior walls of the body 20. The template insert 60 would then rest on the ledge.

In other embodiments, supports may be used to support the template insert 60. The supports may extend downward from the template insert 60, or may be disposed on the interior horizontal surface.

Further, the top 30 does not need to be a solid sheet of material. In certain embodiments, the top 30 may be constructed of a different material, such as a metal mesh. This may allow the plants to grow through the top 30, if desired.

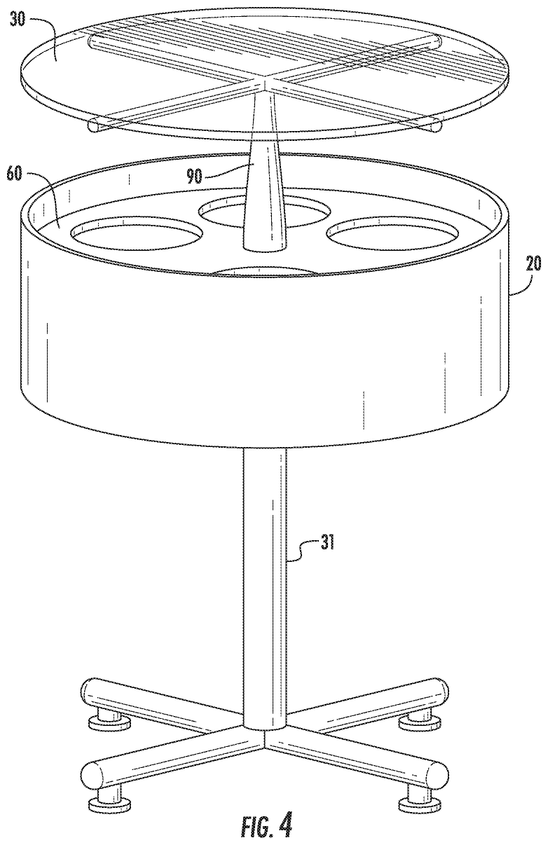

Of course, other embodiments are also possible. FIG. 4 shows a piece of furniture having a body 20 with a template insert 60. In this embodiment, the body 20 is cylindrical rather than prism shaped. Further, rather than being supported by legs, the top 30 is held up by a support 90 that rests on the template insert 60. Further, while FIG. 4 shows a piece of furniture having a central leg 31, it is understood that in certain embodiments, the body 20 may rest on the floor without any legs.

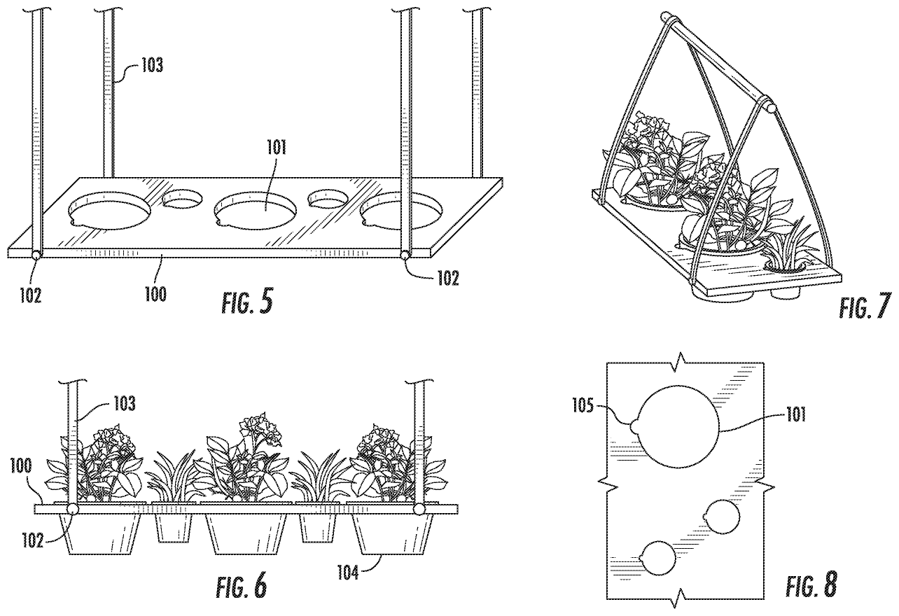

Additionally, the template insert shown in FIG. 3 can be utilized in other pieces of furniture. For example, FIG. 5 shows a hanging piece of furniture, such as a hanging shelf, that makes use of a template insert 100. FIG. 6 shows a side view of the hanging piece of furniture, populated with plants. FIG. 7. shows a perspective view of the hanging piece of furniture.

The template insert 100 may include one or more openings 101. The pattern of openings 101 may be referred to as a template. The openings 101 may be different sizes, such as those shown in FIG. 5 and FIG. 8. In the example shown in FIG. 5, openings are created to accommodate 2″, 4″ and 6″ diameter round flower pots. Of course, other sizes may also be used. In some embodiments, the holes may be sized such that the collar of a typical flower pot remains above the template insert 100, while the rest of the flower pot is suspended below the template insert 100.

Rods 102 may protrude from the sides of the template insert 100. In one embodiment, these rods 102 extend proximate the ends of the template insert 100. In certain embodiments, there are two rods, wherein each rod extends through the template insert 100 in a width direction. In other embodiments, there may be four rods where none of the rods extend through the template insert 100. Rather, in this embodiment, the rods may be inserted only a portion of the way into the template insert 100.

Cables 103, string, or ropes may be affixed to the rods 102 and used to suspend the hanging price of furniture from a ceiling or other structure. For example, in one embodiment, shown in FIG. 7, the cables may be tied to a curtain rod or other window treatment holder. In another embodiments, hooks may be installed in the ceiling or walls and used to hold the cables 103.

In certain embodiments, as shown in FIG. 6, each opening 101 has an associated container 104. These containers 104 may be suspended from the bottom surface of the template insert 100. In other embodiments, these containers 104 go through the openings 101. This tray 104 is waterproof and is used to capture any water that passes through the flower pots located in the openings 101. In certain embodiments, the flower pots pass through the openings 101 and are supported by the tray 104. In other embodiments, as stated above, the openings 101 are sized to retain the collar of a flower pot.

In certain embodiments, each opening 101 has a notch 105, as best seen in FIG. 8. The notch 105 allows water to the added directly to the container 104 and absorbed by the potted plant through holes in the bottom of the flower pot.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A piece of furniture, comprising:
a body having a hollow interior, a bottom surface and walls, wherein a top side of the bottom surface is an interior horizontal surface;
a bottom insert disposed on the interior horizontal surface and comprising a lower surface and vertical sides extending upward from the lower surface;
a template insert disposed on a top surface of the vertical sides, the template insert comprising a plurality of openings, wherein each opening is configured to accommodate a flower pot; and
a top disposed above the body.

2. The piece of furniture of claim 1, wherein the bottom insert is waterproof such that water does not contact the body.

3. The piece of furniture of claim 1, wherein the top is clear.

4. The piece of furniture of claim 3, wherein the top is constructed of a material and thickness so as to support at least 5 pounds.

5. The piece of furniture of claim 1, wherein the top is a metal mesh.

6. The piece of furniture of claim 1, wherein a hole is disposed through one of the walls to allow water to be added onto the bottom insert.

7. The piece of furniture of claim 1, further comprising legs attached to the body.

8. The piece of furniture of claim 7, wherein the legs support the top.

9. The piece of furniture of claim 1, further comprising a support that rests on the template insert, wherein the top is disposed above the body using the support.

10. The piece of furniture of claim 1, wherein the vertical sides extend upward from the lower surface by a length of between 4 and 12 inches.

11. The piece of furniture of claim 1, wherein a space between the template insert and the top is between 4 and 12 inches.

12. A piece of furniture, comprising:
a body having a hollow interior, a bottom surface and walls, wherein a top side of the bottom surface is an interior horizontal surface and wherein the interior horizontal surface is coated with a waterproof coating;
a template insert disposed in the hollow interior above the interior horizontal surface, the template insert comprising a plurality of openings, wherein each opening is configured to accommodate a flower pot; and
a top disposed above the body.

13. The piece of furniture of claim 12, further comprising supports to hold the template insert above the interior horizontal surface.

14. The piece of furniture of claim 12, further comprising a ledge disposed along an interior surface of the walls, wherein the ledge is configured to hold the template insert above the interior horizontal surface.

15. The piece of furniture of claim 12, further comprising legs attached to the body.

16. The piece of furniture of claim 15, wherein the legs support the top.

17. The piece of furniture of claim 12, further comprising a support that rests on the template insert, wherein the top is disposed above the body using the support.

18. A hanging piece of furniture comprising:
a template insert, the template insert comprising a plurality of openings, wherein each opening is configured to accommodate a flower pot;
a waterproof container suspended from each opening; and
rods disposed proximate the ends of the template insert, to allow the template insert to be suspended from above.

19. The hanging piece of furniture of claim 18, wherein the rods pass through an entirety of a width of the template insert.

20. The hanging piece of furniture of claim 18, wherein each opening comprises a notch to allow water to be added directly into the waterproof container.
